(19) United States
(12) Patent Application Publication
(10) Pub. No.: US 2007/0283795 A1
(43) Pub. Date: Dec. 13, 2007

(54) Punch plug arrangement

(76) Inventor: Richard J. Greenleaf, Manchester, MA (US)

Correspondence Address: Donald N. Halgren, 35 Central Street, Manchester, MA, 01944, US

(21) Appl. No.: 11/450,526

(22) Filed: Jun. 9, 2006

(51) Int. Cl. B26F 1/14

(52) U.S. Cl. 83/684

(57) ABSTRACT

An elongated punch arrangement for a punch press assembly for punching a sheet metal plug through a die. The punch arrangement comprises an elongated punch having a distal end and a proximal end. A bore is longitudinally arranged in the elongated punch. An elastomeric insert is securably disposed within the bore. The insert has a distal end extending distally beyond the distal end of the punch. The distal end of the insert preferably comprises at least three dome shaped extensions for pressing engagement of a plug during movement of the punch within the die during the punching operation.

### BACKGROUND OF THE INVENTION

1. Field of the Invention

This invention relates to a punch for the stamping industry, and more particularly to a plug for safely and efficiently pushing a slug from a die once that punch has pierced a piece of metal on that die.

2. Prior Arts

In the stamping industry, a shaped punch of a punch press is driven through a sheet of material and into a die to punch out a part such as a washer or the like. The problem with this procedure is that many times that part will not be driven out when the punch is reversed and pulled from the die.

Part of this problem is caused by lubrication in the die, which causes a slight pull-in and suction when the punch is withdrawn from that die. It is desired that that part should be ejected out of the backside of the die once the punch has made its hit through the sheet metal.

U.S. Pat. No. 4,516,450 to Shuttleworth shows a slug retaining die for a print press wherein the die has an inwardly extending protrusion arranged to encounter and grip the edge of a punched slug. This however, limits the depth of travel and may shorten the life of the punch. A much more complicated procedure is shown in U.S. Pat. No. 4,995,289 to Vakermans, that make a particular die opening with an insert therein. The insert may be reversed during the operation. US Patent application 2002/0078836 to Goyette et el shows a stamp die device having a die that is designed with a tapered area and a non tapered area to provide a longer stamp die life to minimize slug pulling problems.

It is an object of the present invention to overcome those disadvantages of the prior art.

It is yet a further object of the present invention, to provide a simple and fail safe arrangement for driving a plug through a die without having it pulled back during the punch reversal.

It is yet still a further object of the present invention, to provide a slug ejection arrangement which is inexpensive, easily replaced with a particular die and punch and is economical to manufacture and utilize.

### BRIEF SUMMARY OF THE INVENTION

The present invention relates to the metal stamping industry in which a die punch, typically circular in cross section, (although it may be of any cross sectional shape), is pressed through a piece of sheet metal, and through a die or opening through which a plug of that shape metal is pressed. A punch of the present invention is for example, circular in cross section having a cylindrical bore extending longitudinally therethrough. The punch has a distalmost end having a sharp peripheral edge which pierces the sheet metal creating a slug, which then intendedly pushes that sheet metal slug through the shaped die therebeneath. That punch has a proximal end typically with an annular lip or shoulder thereon for securement of that punch in a press or driving means for moving that punch through the die. The punch has that longitudinal bore therethrough, from the distal end to the proximal end in a first preferred embodiment thereof. That internal bore may be tapered, with the widest end of that bore disposed at the distalmost end of the punch.

In a first aspect of the present invention, an elongated ejection plug is disposed within the elongated bore of the punch. The elongated ejection plug in a preferred embodiment thereof may comprise a soft elastomeric material having a distalmost end and a proximal end. An end view of the ejector plug may look like a clover shaped device. The ejector plug may be comprised of three parallel, elongated flanges which mate snuggly within the bore of the punch. The distal end of the ejector plug has three extensions thereon which are preferably hemispherically shaped. The hemispherically shaped distalmost end of the ejection plug extends distally beyond the distal end of the punch.

In yet a further embodiment of the present invention, the longitudinal bore of extending through the elongated generally cylindrically shaped punch, may be of “clover” shape, while still having a plurality of elongated individually extruded ejector plugs extending therethrough. Each individual ejector plug in this embodiment has a distalmost end of slight round configuration. The distalmost ends each extending slightly distally (out of and) beyond the distal end of the punch. A central lumen of the longitudinal bore extending through the punch is disposed within the geometric location of the outwardly disposed ejection plugs disposed therein. An elongated screw may be disposed within that central lumen, so as to lock the three ejection plugs snuggly within their respective parallel bores. The threaded screw is preferably a polymeric material or other resilient non-metallic material.

A further embodiment of the ejection plug may be comprised of a generally cylindrically extruded elongated polymeric member having a proximal end and a distal end, the distal end having at least three hemispherical or semi-spherical protrusions thereon, surrounding a central bore extending through that ejection plug. That central bore may be utilized for a polymeric screw extending therethrough to expand that ejection plug within the walls of the bore through the elongated punch.

A yet further embodiment of the present invention comprises an elongated punch, having a proximal end and a distal end. The distal end has a bore extending part way therein, comprising a “blind hole” in that punch. An elongated ejection plug, of for example, generally cylindrical shape, having a proximal end and a distal end is insertable within that elongated blind hole through the distal end of the punch. The elongated ejection plug in this embodiment may have a central bore therethrough for receipt of a screw therewithin. That screw may be utilized to expand the walls of the ejection plug, and/or to attach the ejection plug to a threaded bore centrally within the bottom of the blind hole. The distalmost end of this particular ejection plug preferably has at least three hemispherical extensions or protruberances thereon, extending distally beyond the distalmost end of the punch in which the ejection plug is inserted. The hole in this embodiment is preferably tapered to a wider dimension towards its distal end.

In operation of the ejection plug arrangement for a punch present system, the distalmost end of the ejection insert, extends beyond the distalmost end of the punch so that when the punch presses through a piece of sheet metal in longitudinal engagement with a die, those protruberances extending beyond the distal end of the punch compress slightly but give enough pressure to the slug being punched through the die, so as to completely eject it therethrough and out the other side of that die. That slug does not get held up or put into misalignment within the die itself, because of the spaced apart triangular nature of the hemispherical ejection plugs pushing thereagainst, from the distal end of the punch.

The invention thus comprises an elongated punch arrangement for a punch press assembly for punching a sheet metal plug through a die. The punch arrangement comprises an elongated punch having a distal end and a proximal end, a bore arranged in the elongated punch, and an elastomeric insert is disposed within the bore, the insert having a distal end extending distally beyond the distal end of the punch. The bore extends longitudinally through the punch from the distal end to preferably the proximal end thereof. The bore is preferably of “clover” shaped pattern in cross-sectional shape. The bore extending from the distal end of the punch may also comprise a blind hole. The bore and/or the insert may be tapered. The taper is preferably widest at the distal end of the punch. The distal end of the insert comprises preferably at least one generally hemispherically shaped dome. The insert may in one embodiment, have a bore extending longitudinally therethrough. A screw may be arranged through the bore in the insert to help secure the insert within the punch. The insert preferably comprises an odd number of hemispherically shaped domes on its distal end thereof, extending beyond the distal end of the punch.

The invention may also comprise an elongated punch insert for installation into a punch for stamping parts out through a die in a punch press. The punch insert may comprise an elongated resilient member having a proximal end and a distal end, and at least one protrusion extending off of the distal end of the member so as to extend beyond the punch to push a stamped part out through the die after the punch has punched the part into the die. The elongated member may be of tapered dimension along its longitudinal axis. The protrusion is preferably hemispherically shaped for proper pushable engagement of the punched part.

The invention may also comprise a method of producing a punched part in a punch press and die arrangement while eliminating any retention of the part in the die comprising one or more of the following: arranging a longitudinally directed bore in a punch, inserting an elongated resilient insert member into the bore in the punch; arranging a distal end of the insert member to extend distally beyond the distal end of the punch during the punching operation; resiliently pushing the punched part out through the die after the punch has punched the part into the opening comprising die; inserting a screw into the bore of the punch after insertion of the resilient member therein; forming a rounded end on the distal end of the resilient member; and forming the resilient member into a longitudinally tapered shape.

### BRIEF DESCRIPTION OF THE DRAWINGS

The objects and advantages of the present invention will become more apparent, when viewed in conjunction with the following drawings in which:

FIG. 1 is a perspective view of an elongated punch of the present invention, having a central bore with an ejection plug extending slightly therefrom;

FIG. 1A is a side elevational view, partly in section, showing a punch arranged adjacent a die with a piece of sheet metal arranged therebetween;

FIG. 2 is a perspective view of an ejection plug constructed according to the principles of the present invention;

FIG. 3 is a perspective view of a punch, with a plurality of elongated bores extending therethrough, with a further bore for receipt of a retaining screw therewithin;

FIG. 4 is a side elevational view of a punch in transverse section, showing an ejection plug extending therewithin;

FIG. 5 is a view taken along the lines 5-5 of FIG. 4;

FIG. 6 is a view similar to FIG. 4, showing an elongated punch with a bore extending therethrough and a further embodiment of an ejection plug therewithin;

FIG. 7 is a view taken along the lines 7-7 of FIG. 6;

FIG. 8 is a side elevational view of an elongated punch in transverse section, showing an elongated ejection plug extending therewithin;

FIG. 9 is a side elevational view of the ejection plug shown in FIG. 8; and

FIG. 10 is a view taken along the lines 10-10 of FIG. 9.

### DETAILED DESCRIPTION OF THE PREFERRED EMBODIMENTS

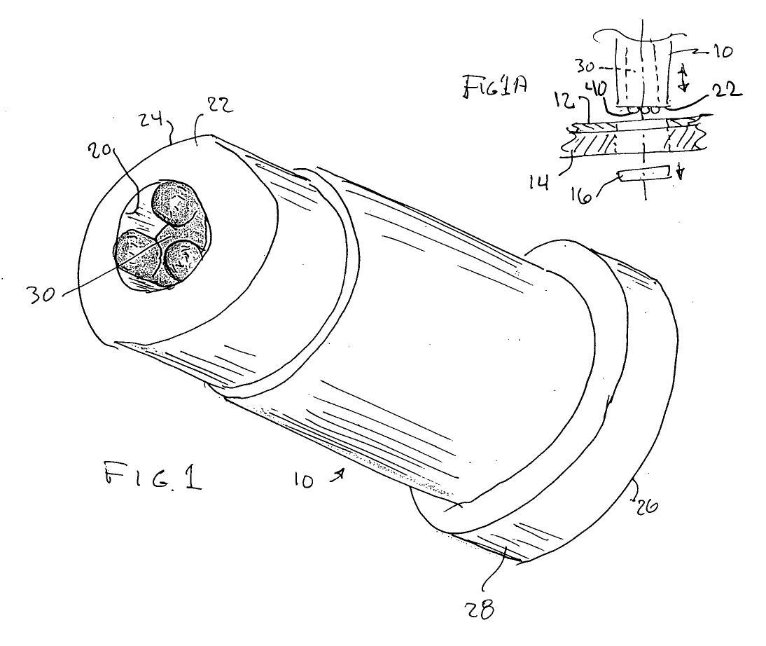

Referring now to the drawings in detail, and particularly to FIG. 1, there is shown the present invention which comprises a die punch 10 for the metal stamping industry. The die punch 10 for our description purposes, is circular in cross section, (although it may be of any cross sectional shape), is driven through a piece of sheet metal 12, and through a die 14 or opening through which a plug 16 of that shape metal 12 is pressed, as represented in FIG. 1A. A punch 10 of the present invention is for example, circular in cross section, as may be seen in FIGS. 1 3, 5 and 7, having a cylindrical bore 20 extending longitudinally therethrough, as represented in FIGS. 4 and 6. The punch 10 has a distalmost end 22 having a sharp peripheral edge 24 which pierces the sheet metal 12 creating the slug 16. The punch 10 then intendedly pushes that sheet metal slug 16 through the shaped die 14 there adjacent. That punch 10 has a proximal end 26 typically with an annular lip or shoulder 28 thereon for securement of that punch 10 in a press or driving means (not shown for clarity of figures) for moving that punch 10 through the die 14.

The punch 10 has that longitudinal bore 20 extending therethrough, from the distal end 22 to the proximal end 26 in a first preferred embodiment thereof. That internal bore 20 may be slightly tapered, with the widest end of that bore 20 disposed at the distalmost end 22 of the punch 10, for securement purposed described hereinbelow.

In a first aspect of the present invention, an elongated ejection plug 30 is disposed within the elongated bore 20 of the punch 10, as represented in FIG. 1. The elongated ejection plug 30, in a preferred embodiment thereof may comprise a soft elastomeric material having a distalmost end 32 and a proximal end 34, as represented in FIG. 2. An end view of the ejector plug 30 may look like a clover shaped device. The ejector plug 30 may preferably be comprised of three parallel, elongated lobes or flanges 36 which mate snuggly within the bore 20 of the punch 10. The distal end 32 of the ejector plug 30 has three extensions 40 thereon which are preferably hemispherically shaped, as represented in FIGS. 1, 1A and 2. The hemispherically shaped distalmost end extensions 40 of the ejection plug extends distally beyond the distal end 22 of the punch 10, as may be seen in FIGS. 1, 1A, 4, 6 and 8.

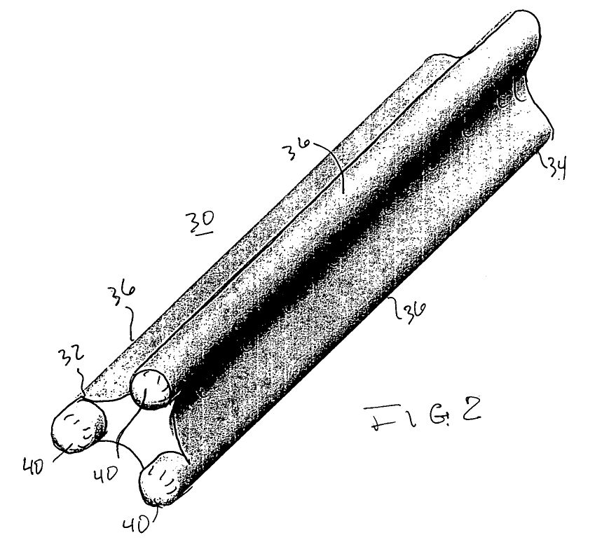

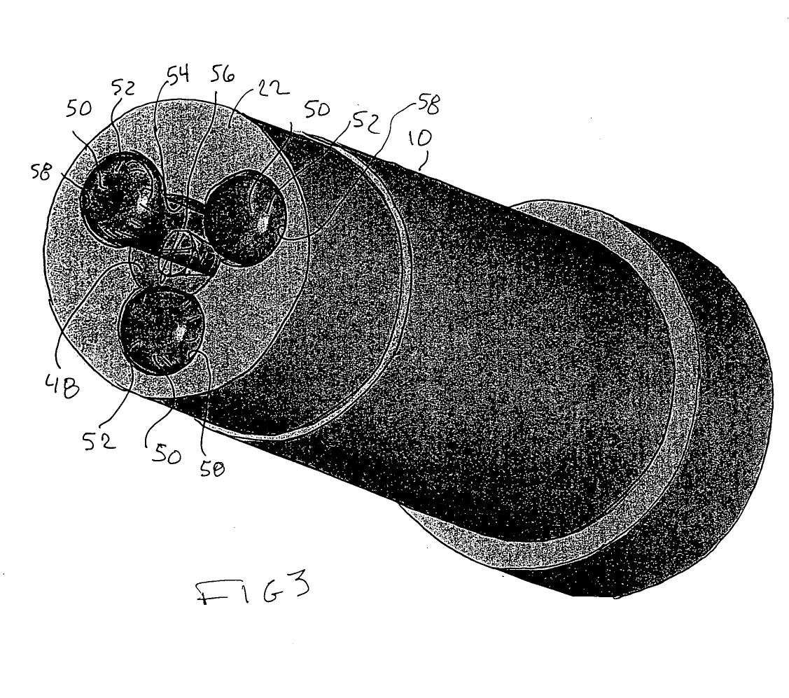

In yet a further embodiment of the present invention, a longitudinal main bore 48 extending through the elongated generally cylindrically shaped punch 10 may itself may be of “clover” shape, as represented in FIG. 3, while having a plurality of elongated individually extruded ejector plugs 50 extending therethrough. Each individual ejector plug 50 in this embodiment has a distalmost end 52 of slight round or hemispherical configuration. The distalmost ends 52 each extending slightly distally (out of and) beyond the distal end 22 of the punch 10. A central lumen 54 of the longitudinal bore 48 extending through the punch 10 is disposed within the geometric longitudinally centralized location of the outwardly disposed ejection plugs 50 disposed therein. An elongated screw 56 may be disposed within that central lumen 54, so as to lock the three ejection plugs 50 snuggly within their respective parallel bores 58 of the main bore 48. The threaded screw 56 is preferably a polymeric material or other resilient non-metallic material.

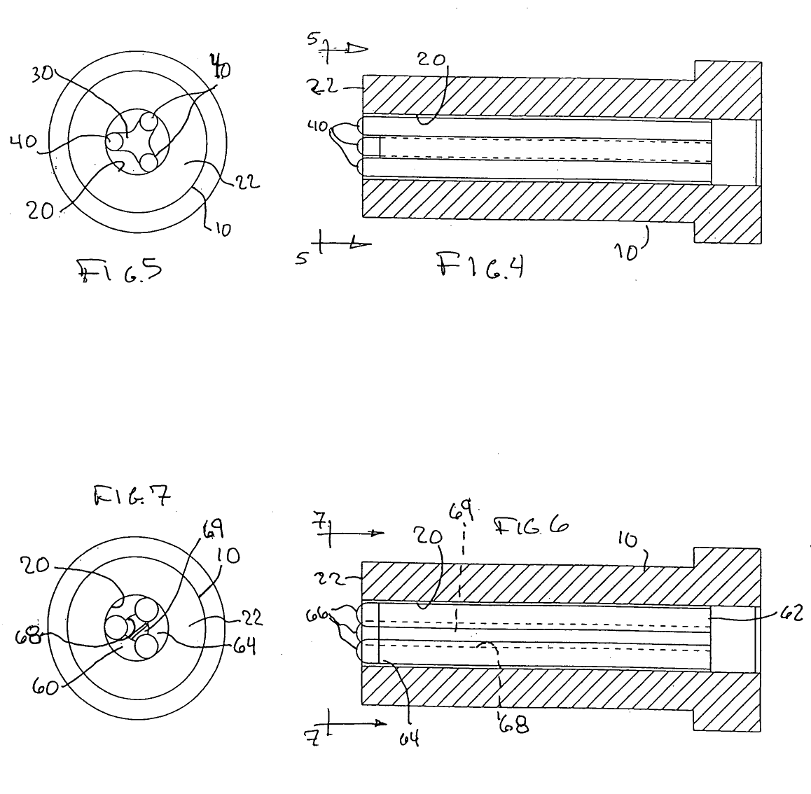

A further embodiment of the ejection plug 30, is shown in FIGS. 6 and 7. The plug 30 is shown best in FIG. 7, may be comprised of a generally cylindrically extruded elongated polymeric member 60 having a proximal end 62 and a distal end 64. The distal end 64 having at least three hemispherical or semi-spherical protrusions 66 thereon, surrounding a central bore 68 extending through that ejection plug 60. That central bore 66 may be utilized for a polymeric screw 69 extending therethrough to expand that ejection plug 66 within the walls of the bore 20 through the elongated punch 10.

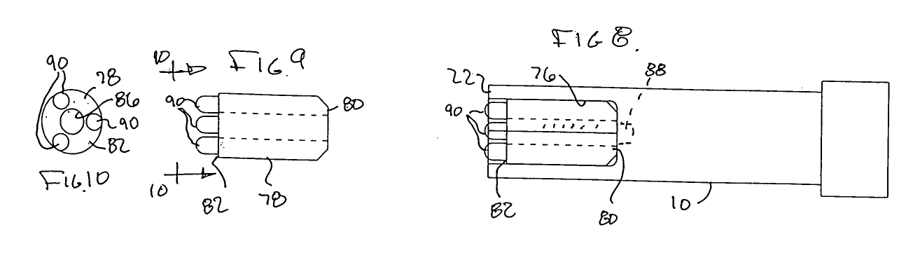

A yet further embodiment of the present invention comprises an elongated punch 70, having a proximal end 26 and a distal end 22, as represented in FIGS. 8 and 9. The distal end 74 has a bore 76 extending part way therein, comprising a “blind hole” in that punch 10. An elongated ejection plug 78, generally cylindrical shape, having a proximal end 80 and a distal end 82 is insertable within that elongated blind hole 76 through the distal end 22 of the punch 10. The elongated ejection plug 78 in this embodiment may have a central bore 86 therethrough for receipt of a screw, not shown for clarity, therewithin. That screw may be utilized to expand the walls of the ejection plug 78, and/or to attach the ejection plug 78 to a threaded bore 88, centrally within the bottom of the blind hole 76, as represented in FIG. 8. The distalmost end 82 of this particular ejection plug 78 preferably has at least three hemispherical extensions or protruberances 90 thereon, extending distally beyond the distalmost end 22 of the punch 10 in which the ejection plug 78 is inserted. The hole or bore 76 in this embodiment is preferably tapered to a wider dimension towards its distal end.

In operation of the ejection plug arrangement for a punch present system as represented in FIG. 1a, the distalmost end of the ejection plug insert, extends beyond the distalmost end 22 of the punch 10 so that when the punch presses through a piece of sheet metal 12 in longitudinal engagement with a die 14, those protruberances 40 et al. extending beyond the distal end 22 of the punch 10 do compress slightly but give enough pressure to the slug 16 being punched through the die, so as to completely eject it therethrough and out the other side of that die. That slug does not get held up or put into misalignment within the die 14 itself, because of the spaced apart triangular nature of the hemispherical ended ejection plugs 40 etc. pushing thereagainst, from the distal end 22 of the punch 10.

1. An elongated punch arrangement for a punch press assembly for punching a sheet metal plug through a die, said punch arrangement comprising:
an elongated punch having a distal end and a proximal end;
a bore arranged in said elongated punch; and
an elastomeric insert disposed within said bore of said punch, said insert having a distal end extending distally beyond said distal end of said punch.

2. The elongated punch arrangement as recited in claim 1, wherein said bore extends longitudinally through said punch from said distal end to said proximal end thereof.

3. The elongated punch arrangement as recited in claim 1, wherein said bore is of “clover” shaped pattern in cross-sectional shape.

4. The elongated punch arrangement as recited in claim 1, wherein said bore extending from said distal end of said punch comprises a blind hole.

5. The elongated punch arrangement as recited in claim 1, wherein said bore is tapered.

6. The elongated punch arrangement as recited in claim 5, wherein said taper is widest at said distal end of said punch.

7. The elongated punch arrangement as recited in claim 1, wherein said distal end of said insert comprises at least one generally hemispherically shaped dome.

8. The elongated punch arrangement as recited in claim 1, wherein said insert has a bore extending longitudinally therethrough.

9. The elongated punch arrangement as recited in claim 8, including a screw arranged through said bore in said insert to help secure said insert within said punch.

10. The elongated punch arrangement as recited in claim 1, wherein said insert comprises an odd number of hemispherically shaped domes on its distal end thereof, extending beyond said distal end of said punch.

11. An elongated punch insert for installation into a punch for stamping parts out through a die in a punch press, said punch insert comprising:
an elongated resilient member having a proximal end and a distal end; and
at least one protrusion extending off of said distal end of said member to extend beyond said punch to push a stamped part out through said die after said punch has punched said part into said die.

12. The elongated punch insert as recited in claim 11, wherein said elongated member is of tapered dimension along its longitudinal axis.

13. The elongated punch insert as recited in claim 11, wherein said protrusion is hemispherically shaped.

14. A method of producing a punched part in a punch press and die arrangement while eliminating any undesired retention of said part in said die comprising:
arranging a longitudinally directed bore in a punch;
inserting an elongated resilient insert member into said bore in said punch;
arranging a distal end of said insert member to extend distally beyond the distal end of said punch during the punching operation; and
resiliently pushing said punched part out through said die after said punch has punched said part into said die.

15. The method as recited in claim 14, including:
inserting a screw into said bore of said punch after insertion of said resilient member therein to secure said resilient member therein.

16. The method as recited in claim 14, including:
forming a rounded end on said distal end of said resilient member.

17. The method as recited in claim 14, including:
forming said resilient member into a longitudinally tapered shape.

18. The method as recited in claim 14, wherein said bore is tapered in said punch.
